(19) United States
(12) Patent Application Publication
(10) Pub. No.: US 2018/0197532 A1
(43) Pub. Date: Jul. 12, 2018

(54) AUDIO CONTENT CENSORING IN VEHICLE INFOTAINMENT SYSTEM

(71) Applicant: Panasonic Automotive Systems Company of America, Division of Panasonic Corporation of North America, Peachtree City, GA (US)

(72) Inventors: SHANTHA KUMARI RAJENDRAN, FARMINGTON HILLS, MI (US); ROHAN RAMDAS REPALE, FARMINGTON HILLS, MI (US)

(73) Assignee: Panasonic Automotive Systems Company of America, Division of Panasonic Corporation of North America

(21) Appl. No.: 15/846,619

(22) Filed: Dec. 19, 2017

Related U.S. Application Data
(60) Provisional application No. 62/444,420, filed on Jan. 10, 2017.

(51) Int. Cl. G10L 15/08; G10L 15/22; G10L 21/02

(52) U.S. Cl. CPC G10L 15/08; G10L 2015/088; G10L 21/02; G10L 15/22

(57) ABSTRACT

An automotive infotainment system includes a source of a first audio content signal. The first audio content signal includes spoken or sung words. An electronic processor receives the first audio content signal, and identifies a predetermined objectionable word among the words in the first audio content signal. A buffer receives and temporarily stores the first audio content signal. The buffer transmits a second audio content signal. The second audio content signal is a censored and delayed version of the first audio content signal. The electronic processor removes a portion of the first audio content signal including the predetermined objectionable word to thereby produce the second audio content signal in the buffer. A loudspeaker is driven by the second audio content signal and thereby produces audible sounds corresponding to the second audio content

### CROSS-REFERENCED TO RELATED APPLICATIONS

This application claims benefit of U.S. Provisional Application. No. 62/444,420 filed Jan. 10, 2017, which the disclosure of which is hereby incorporated by reference in its entirety for all purposes.

### FIELD OF THE INVENTION

The disclosure relates to an infotainment system for a vehicle, and, more particularly, to modifying the content presented by an infotainment system for a vehicle,

### BACKGROUND OF THE INVENTION

Current infotainment systems do not provide any capability to mute, filter out, or censor offensive or vulgar words from the audio content that a user is listening to.

### SUMMARY

The present invention may censor or filter out offensive or vulgar words played on an in-vehicle audio system. The offensive words may be identified by retrieving text song lyrics from a server, or by performing audio-to-text conversion if text lyrics are not available. The audio containing the offensive words may be muted or replaced by a beep or tone while the infotainment unit is playing the song. The songs may be buffered in order to avoid processing delays. The user may have the option of entering words to be filtered or censored out.

In one embodiment, the invention comprises an automotive infotainment system including a source of a first audio content signal. The first audio content signal includes spoken or sung words. An electronic processor receives the first audio content signal, and identifies a predetermined objectionable word among the words in the first audio content signal. A buffer receives and temporarily stores the first audio content signal. The buffer transmits a second audio content signal. The second audio content signal is a censored and delayed version of the first audio content signal. The electronic processor removes a portion of the first audio content signal including the predetermined objectionable word to thereby produce the second audio content signal in the buffer. A loudspeaker is driven by the second audio content signal and thereby produces audible sounds corresponding to the second audio content signal.

In another embodiment, the invention comprises a method of operating an automotive infotainment system, including providing a first audio content signal. The first audio content signal includes spoken or sung words. The first audio content signal is temporarily stored in a buffer. A predetermined objectionable word is identified among the words in the first audio content signal. A portion of the first audio content signal is removed from the buffer to thereby produce a second audio content signal in the buffer. The removed portion of the first audio content signal includes the predetermined objectionable word. The second audio content signal is a censored and delayed version of the first audio content signal. The second audio content signal is transmitted from the buffer to drive a loudspeaker and thereby produce audible sounds corresponding to the second audio content signal.

In yet another embodiment, the invention comprises a method of operating an automotive infotainment system, including providing a first audio content signal. The first audio content signal includes spoken or sung words. The first audio content signal is temporarily stored in a buffer. A speech-to-text module is used to convert the first audio content signal into text words. A predetermined objectionable word is identified among the text words. A portion of the first audio content signal is removed from the buffer to thereby produce a second audio content signal in the buffer. The removed portion of the first audio content signal includes the predetermined objectionable word. The second audio content signal is a censored and delayed version of the first audio content signal. The second audio content signal is transmitted from the buffer to drive a loudspeaker and thereby produce audible sounds corresponding to the second audio content signal.

An advantage of the present invention is that age-inappropriate words may be filtered out of the playing of the audio content.

### BRIEF DESCRIPTION OF THE DRAWINGS

A better understanding of the present invention will be had upon reference to the following description in conjunction with the accompanying drawings.

FIG. 1 is a block diagram of one embodiment of an audio censoring arrangement of the present invention,

FIG. 2 is a flow chart of one embodiment of an audio censoring method of the present invention.

FIG. 3 is a flow chart of one embodiment of a method of the present invention for operating an automotive infotainment system.

### DETAILED DESCRIPTION OF THE PREFERRED EMBODIMENTS

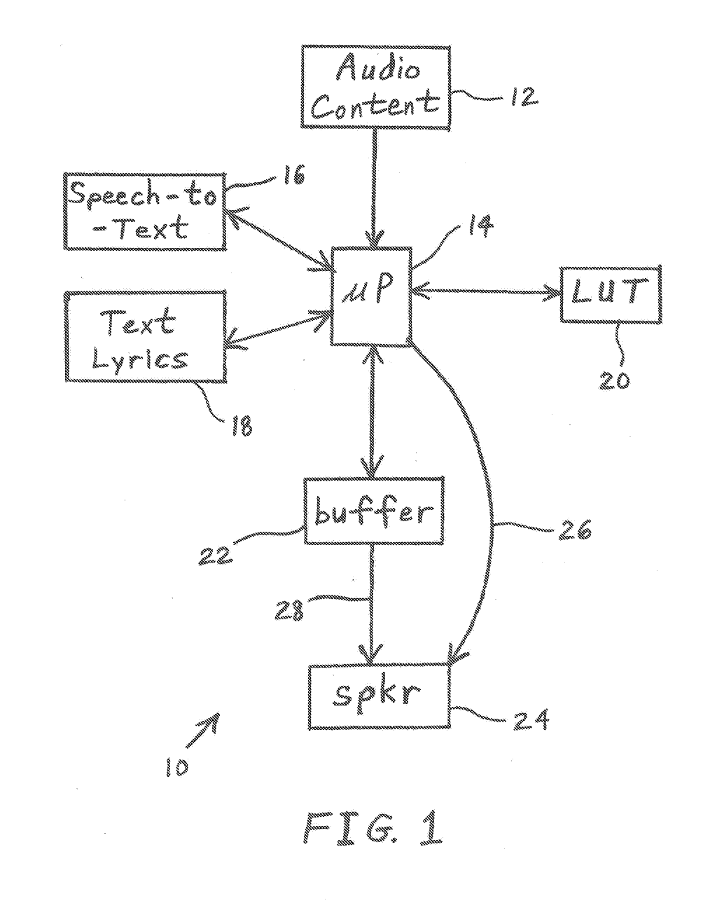

FIG. 1 illustrates one embodiment of an audio censoring arrangement 10 of the present invention, including a source of audio content 12, an electronic processor 14, a speech-to-text module 16, a source of text lyrics 18, a lookup table 20, a buffer 22, and a loudspeaker 24. Source of audio content 12 may be a radio or some type of storage device, such as a compact disc, an iPod, or an MP3 player, for example.

Speech-to-text module 16 may receive as an input an audio signal including a song being sung, and may convert the lyrics that are sung into text words. Source of text lyrics 18 may provide a text transcript of the lyrics of identified songs, and may specify a respective particular span of time during which each word of the lyrics is sung in the song.

Lookup table 20 may include lists of words which are to be censored under various levels of filtering. For example, a first level of filtering may be applied by a user when teenage children are listening, and may include a relatively short list of objectionable words. However, when small children are listening, a second level of filtering may be applied by the user that may include a relatively longer list of objectionable words that the user does not want the small children to hear.

During use, processor 14 may receive an audio content signal from source 12 including a song or speech having vulgar or otherwise objectionable words. Processor 14 may then input the audio content signal, possibly with the musical portion removed, to speech-to-text module 16. Speech-to-text module 16 may return to processor 14 the lyrics of the song in text form substantially in real-time (e.g., continuously while the song is still playing).

Instead of, or in addition to, use of speech-to-text module 16, processor 14 may identify the currently playing song to source of text lyrics 18. Source of text lyrics 18 may provide processor 14 with the lyrics of the identified song in text form, along with an identification of the respective time period within the song during which each word of the lyrics is sung.

Instead of, or in addition to, use of speech-to-text module 16 and source of text lyrics 18, processor 14 may obtain the song lyrics from the metadata embedded in the audio content signal from source 12. Each word of the test lyrics may be provided in the metadata contemporaneously with the singing of the word in the song.

After receiving the text lyrics of the song, processor 14 may check, for each word of the lyrics, whether that word is included in the applicable list of objectionable words in lookup table 20. If a particular word is not included in the applicable list, then the corresponding music and singing is temporarily stored in buffer 22 for a few seconds before being used to drive loudspeaker 24, which results in the music and singing being audibly played on loudspeaker 24.

However, if a particular word of the lyrics is included in the applicable list in lookup table 20 of words to be censored, then processor 14 may retrieve a corresponding portion of the music and singing (e.g., the corresponding portion of the audio content signal) from buffer 22. The retrieved corresponding portion of the music and singing may include only that portion starting with the beginning of the singing of the offensive word(s) and ending with the termination of the singing of the offensive word(s). Alternatively, the retrieved corresponding portion of the music and singing may be longer, and may include some music and singing before the beginning of the singing of the offensive word(s) and/or some music and singing after the termination of the singing of the offensive word(s).

Processor 14 may mute, replace with a beep tone, or otherwise remove the offensive words from the retrieved corresponding portion of the music and singing to thereby produce a censored audio signal 26 that processor 14 may use to directly drive loudspeaker 24 without using buffer 22 as an intermediary. The timing of the transmittal of censored audio signal 26 may be such that signal 26 fills the gap in a signal 28 from buffer 22 that has been caused by processor 14 retrieving the corresponding portion of music and singing from buffer 22. For example, the retrieval of the corresponding portion of music and singing from buffer 22 may leave a gap in the signal 28 from buffer 22 that is filled by censored audio signal 26. Thus, there may be minimal interruption and change in timing of the music and singing played on loudspeaker 24 due to the censoring of the offensive words.

Alternatively, instead of transmitting a censored audio signal 26 directly to loudspeaker 24, processor 14 may add content to the portion of buffer 22 from which the censored portion of the audio content was removed. Thus, the signal 28 from buffer 22 may include both the uncensored content as well as replacement content (e.g., a beep tone or silence) that replaces the censored content.

As another alternative, instead of processor 14 transmitting a censored audio signal 26 directly to loudspeaker 24, and instead of processor 14 replacing the censored content in buffer 22 with replacement content in buffer 22, processor 14 may simply remove the censored content from buffer 22. The resulting gap or lack of content in buffer 22 may then result in silence or static being played on loudspeaker 24 instead of the censored content.

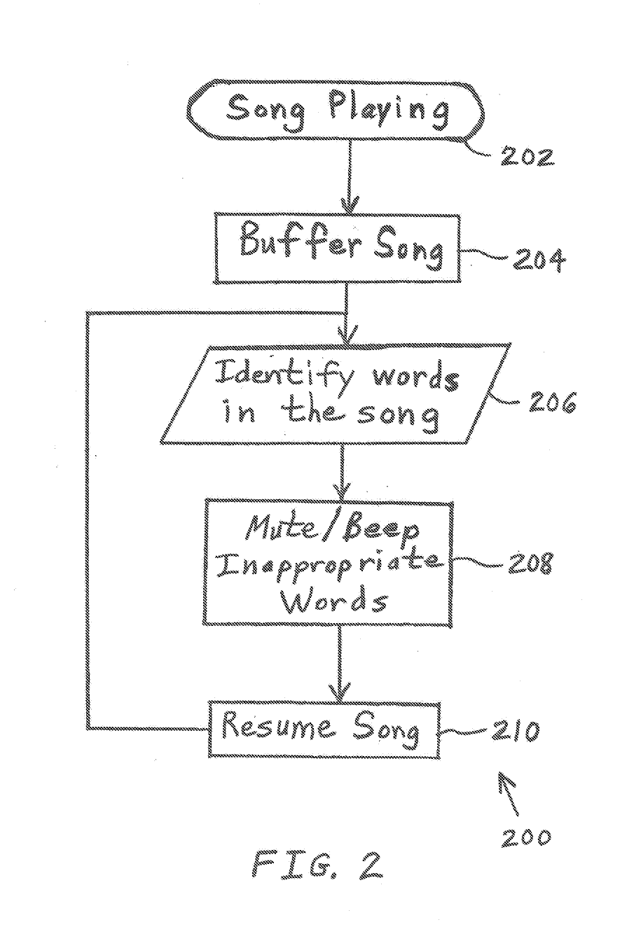

FIG. 2 illustrates one embodiment of an audio censoring method 200 of the present invention. In a first step 202, a song is playing. For example, source of audio content 12 system may be providing an audio content signal, which ultimately results in a song being audibly played on loudspeaker 24, as described above with reference to FIG. 1. In a second step 204, the song is buffered. For example, buffer 22 may continuously store the next few seconds of the song to be played.

In a next step 206, words in the song are identified. For example, processor 14 may send the audio content signal to speech-to-text module 16 so that speech-to-text module 16 can translate the song lyrics, as sung, into text words. Alternatively, processor 14 may, after identifying the song, such as by title, retrieve the words in the song from source of text lyrics 18. As another alternative, processor 14 may obtain the words in the song from metadata included in the audio content signal.

Next, in step 208, inappropriate words are muted or beeped. For example, after referring to lookup table 20 to determine that certain words are to be censored based on being offensive or obscene, processor 14 may retrieve the corresponding portion of the audio content signal from buffer 22 and may delete the corresponding portion or may replace the corresponding portion with a beep tone.

In a final step 210, the playing of the song is resumed and operation returns to step 206. For example, the lyrics of the song may be continued to be monitored, and the music and singing may continue to be audibly played on loudspeaker 24 until the singer again sings an inappropriate word.

Although the invention has been described such that the electronic processor transmits the audio content signal to the buffer, it is also possible within the scope of the invention for the audio content signal to be transmitted directly from the source of audio content to the buffer.

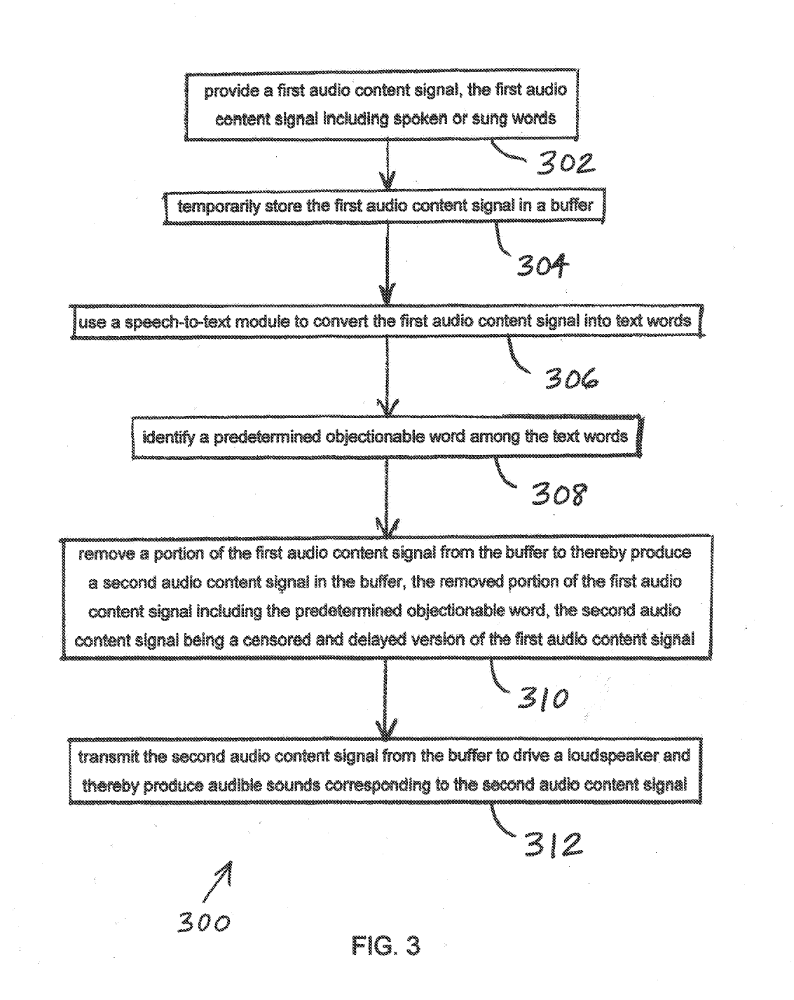

FIG. 3 illustrates one embodiment of a method 300 of the present invention for operating an automotive infotainment system. In a first step 302, a first audio content signal is provided. The first audio content signal includes spoken or sung words. For example, source of audio content 12 may be a radio or some type of storage device that provides an audio content signal including a song or spoken words.

In a next step 304, the first audio content signal is temporarily stored in a buffer. For example, processor 14 may receive the audio content signal from source 12 and temporarily store the contents of the signal in buffer 22.

Next, in step 306, a speech-to-text module is used to convert the first audio content signal into text words. For example, speech-to-text module 16 may receive the audio content signal from source 12, recognize spoken or sung words in the signal, and convert the recognized spoken or sung words into text.

In step 308, a predetermined objectionable word is identified among the text words. For example, lookup table 20 may include lists of objectionable words which may be compared to the text words recognized in the first audio content signal. If any of the text words recognized in the first audio content signal matches an objectionable word on the list, then that text word is thereby identified as an objectionable word.

In a next step 310, a portion of the first audio content signal is removed from the buffer to thereby produce a second audio content signal in the buffer. The removed portion of the first audio content signal includes the predetermined objectionable word. The second audio content signal is a censored and delayed version of the first audio content signal. For example, the portion of the first audio content signal that includes the objectionable words may be erased from buffer 22 to thereby produce a second audio content signal in buffer 22. The second audio content signal may be delayed by a few seconds as compared to the first audio content signal, and may have the objectionable words censored therein.

In a final step 312, the second audio content signal may be transmitted from the buffer to drive a loudspeaker and thereby produce audible sounds corresponding to the second audio content signal. For example, the second audio content signal may be transmitted from buffer 22 to drive loudspeaker 24 and thereby produce audible sounds corresponding to the second audio content signal.

The invention has been described as being applied to an infotainment system in a motor vehicle. However, it is to be understood that the invention may also be applied to any audio system, regardless of whether the audio system is disposed in a motor vehicle.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detail description is given primarily for clearness of understanding and no unnecessary limitations are to be understood therefrom for modifications can be made by those skilled in the art upon reading this disclosure and may be made without departing from the spirit of the invention.

What is claimed is:

1. An automotive infotainment system, comprising:
a source of a first audio content signal, the first audio content signal including spoken or sung words;
an electronic processor configured to:
receive the first audio content signal; and
identify a predetermined objectionable word among the words in the first audio content signal;
a buffer configured to:
receive and temporarily store the first audio content signal; and
transmit a second audio content signal, the second audio content signal being a censored and delayed version of the first audio content signal, wherein the electronic processor is further configured to remove a portion of the first audio content signal including the predetermined objectionable word to thereby produce the second audio content signal in the buffer; and
a loudspeaker configured to be driven by the second audio content signal and thereby produce audible sounds corresponding to the second audio content signal.

2. The system of claim 1 wherein the source of a first audio content signal comprises at least one of a radio, a compact disc, an iPod, or an MP3 player.

3. The system of claim 1 wherein the electronic processor is configured to identify the predetermined objectionable word among the words in the first audio content signal by use of a speech-to-text module.

4. The system of claim 1 wherein the electronic processor is configured to identify the predetermined objectionable word among the words in the first audio content signal by use of a repository of text song lyrics.

5. The system of claim 1 wherein the electronic processor is configured to identify the predetermined objectionable word among the words in the first audio content signal by use of a lookup table, the lookup table including a list of predetermined objectionable words.

6. The system of claim 1 wherein the electronic processor is configured to replace the removed portion of the first audio content signal with replacement content, the replacement content being inserted into the buffer.

7. The system of claim 1 wherein the electronic processor is configured to transmit a censored audio signal directly to the loudspeaker to thereby fill a gap in the second audio content signal received by the loudspeaker from the buffer, the gap corresponding to the removed portion of the first audio content signal.

8. A method of operating an automotive infotainment system, the method comprising the steps of:
providing a first audio content signal, the first audio content signal including spoken or sung words;
temporarily storing the first audio content signal in a buffer;
identifying a predetermined objectionable word among the words in the first audio content signal;
removing a portion of the first audio content signal from the buffer to thereby produce a second audio content signal in the buffer, the removed portion of the first audio content signal including the predetermined objectionable word, the second audio content signal being a censored and delayed version of the first audio content signal; and
transmitting the second audio content signal from the buffer to drive a loudspeaker and thereby produce audible sounds corresponding to the second audio content signal.

9. The method of claim 8 wherein the first audio content signal is provided by one of a radio, a compact disc, an iPod, and an MP3 player.

10. The method of claim 8 wherein the identifying step includes identifying the predetermined objectionable word among the words in the first audio content signal by use of a speech-to-text module.

11. The method of claim 8 wherein the identifying step includes identifying the predetermined objectionable word among the words in the first audio content signal by use of a repository of text song lyrics.

12. The method of claim 8 wherein the identifying step includes identifying the predetermined objectionable word among the words in the first audio content signal by use of a lookup table, the lookup table including a list of predetermined objectionable words.

13. The method of claim 8 further comprising replacing the removed portion of the first audio content signal with replacement content, the replacement content being inserted into the buffer.

14. The method of claim 8 further comprising transmitting a censored audio signal directly to the loudspeaker, the censored audio signal bypassing the buffer, the censored audio signal filling a gap in the second audio content signal received by the loudspeaker from the buffer, the gap corresponding to the removed portion of the first audio content signal.

15. A method of operating an automotive infotainment system, the method comprising the steps of:
providing a first audio content signal, the first audio content signal including spoken or sung words;
temporarily storing the first audio content signal in a buffer;
using a speech-to-text module to convert the first audio content signal into text words;
identifying a predetermined objectionable word among the text words;
removing a portion of the first audio content signal from the buffer to thereby produce a second audio content signal in the buffer, the removed portion of the first audio content signal including the predetermined objectionable word, the second audio content signal being a censored and delayed version of the first audio content signal; and
transmitting the second audio content signal from the buffer to drive a loudspeaker and thereby produce audible sounds corresponding to the second audio content signal.

16. The method of claim 15 wherein the first audio content signal is provided by one of a radio, a compact disc, an iPod, and an MP3 player.

17. The method of claim 15 wherein the text words comprise a first set of text words included in the spoken or sung words in the first audio content signal, the method further comprising using a repository of text song lyrics to determine a second set of text words included in the spoken or sung words in the first audio content signal.

18. The method of claim 15 wherein the identifying step includes identifying the predetermined objectionable word among the words in the first audio content signal by use of a lookup table, the lookup table including a list of predetermined objectionable words.

19. The method of claim 15 further comprising replacing the removed portion of the first audio content signal with replacement content, the replacement content being inserted into the buffer.

20. The method of claim 15 further comprising transmitting a censored audio signal directly to the loudspeaker, the censored audio signal bypassing the buffer, the censored audio signal filling a gap in the second audio content signal received by the loudspeaker from the buffer, the gap corresponding to the removed portion of the first audio content signal.
